(19) United States
(12) Patent Application Publication
(10) Pub. No.: US 2003/0187985 A1
(43) Pub. Date: Oct. 2, 2003

(54) Network access tool for support of high-speed data services

(75) Inventors: Francis Eugene Rohling, Kennesaw, GA (US); Michael Lee Baumgartner, Panama City, FL (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: DVA Group, LLC, Sunnyvale, CA (US)

(21) Appl. No.: 10/313,948

(22) Filed: Dec. 6, 2002

Related U.S. Application Data
(60) Provisional application No. 60/340,539, filed on Dec. 14, 2001.

(51) Int. Cl. G06F 15/173

(52) U.S. Cl. 709/225; 709/224

(57) ABSTRACT

A device for evaluating access to a computer network from a specified location is disclosed comprising an interface for connecting to the computer network at the specified location and a processor coupled to the interface, the processor capable of using the interface to access at least one network component coupled to the computer network. The result of the device attempting to access the at least one network component is used in evaluating access to the computer network from the specified location.

The device may perform a network ping operation in attempting to access the network component. The device may further comprise at least one memory element for storing evaluation data. The device may be capable of reporting evaluation data to a repository external to the device.

The computer network may comprise a plurality of inter-connected networks, such as the Internet.

### CROSS-REFERENCES TO RELATED APPLICATIONS

This application claims the benefit of U.S. Provisional Application No. 60/340,539, filed Dec. 14, 2001, which is incorporated herein by reference.

### STATEMENT AS TO RIGHTS TO INVENTIONS MADE UNDER FEDERALLY SPONSORED RESEARCH OR DEVELOPMENT

NOT APPLICABLE

### REFERENCE TO A “SEQUENCE LISTING,” A TABLE, OR A COMPUTER PROGRAM LISTING APPENDIX SUBMITTED ON A COMPACT DISK

NOT APPLICABLE

### BACKGROUND OF THE INVENTION

In recent years, consumer access (for example, from home or office) to the general internet network has expanded dramatically with the advent of the cable modem, Digital Subscriber Line (DSL), Asymmetric Digital Subscriber Line (ADSL), Integrated Services Digital Network (ISDN), and other consumer targeted enabling technologies. Companies that provide these services are generally called “access providers.” People or businesses that use these services are generally called “consumers” of the access service. Customer Service Representatives (CSRs) working for access providers are responsible for providing support for these services to the consumers. More and more, CSRs are spending valuable time and effort in assisting consumers with complex problems affecting these services.

As the access providers expand their networks and add consumers, they create short access outages that affect a subset of their deployed consumer base. Equally common, consumers also add software and hardware to their computers that cause their network interface to stop working. Consumers, in general, do not have the technical knowledge or impetus to properly diagnose problems with their computer systems and their networks. Many of these consumers call the CSRs when any problem occurs with their web browser or e-mail. CSRs are unable to independently verify whether a problem exists with the access provider's equipment or the consumer's equipment. Instead, they have to talk the consumer through difficult troubleshooting methods that rely on relatively detailed knowledge of the computer's operating system.

To aggravate the CSR's predicament, consumers have been creating private network segments that tie to the access provider networks using bridges and gateway devices available from retail stores. In this case, consumers are often more knowledgeable about the network than the access provider's CSR. Although access providers often state that their CSRs would not support such third party devices, the cost to the access provider in just having the CSR answer the telephone and diagnose the network remains significant relative to the charges the access provider makes.

Existing bridge and gateway devices can actually help CSRs and consumers diagnose the problem better since there exists a “link” light that tells the CSR whether physical media layer connectivity is present. However, they give neither the CSR nor the consumer an indication that the Media Access Control (MAC) or network layers of the internet protocol are operating properly. This often leaves the CSR in a situation where both a normal computer and a bridge/gateway device have physical connectivity, but cannot access full internet network capabilities due to MAC layer connection problems, incorrect configuration of the consumer's equipment, failure of a back office bridge, router, DNS server, mail server, or any number of other pieces of access provider equipment.

A typical CSR call consists of 20 minutes of waiting for a CSR to answer the call, 20 minutes of the CSR determining what the symptoms are, and 20 minutes of actual problem troubleshooting and resolution. This means the consumer has nearly an hour of time invested in each call to the CSR in order to diagnose the problem. It also means the CSR must spend 20 minutes running through his checklist before he knows the condition of the consumer's premises.

Business consumers often contract with internet access providers to deliver an agreed upon Quality of Service (QoS). This often includes specific provisions for a percentage up time and network bandwidth. To date, instrumentation for this service has not been uniform. Both the business consumer and the access provider use different equipment to measure the QoS in different ways. This makes contracts difficult to interpret and difficult to enforce.

Thus, there is a need for a cost effective tool that can be placed into the consumer's premises and has the capability to indicate when it is able to meet a specific set of network access criteria on the access provider's network. The industry and consumer both need the tool to gather a log that contains a history of events that may have caused the consumer problems in network access prior to a call to the CSR. They also need a log with uniform information that can establish the effective quality of service the consumer receives. Such tool must also have sufficient capability and reliability to be accepted by both the consumer and the access provider.

Current methods of DSL and cable modem monitoring rely on using Simple Network Management Protocol (SNMP). This method relies on monitoring the equipment between the access provider's Network Operations Center (NOC) and the Digital Subscriber Line (DSL) or cable modems. Such monitoring only covers a portion of the network used by the consumer's PC or other internet devices. Further, such monitoring verifies only network connectivity, not network access. Network connectivity relates only to the existence of a physical layer link, whereas network access relates to communication at the network layer, as defined in the Open Systems Interconnection (OSI) standard. Thus, there exists a need to verify portions of the utilized network that is not covered by currently available methods and to perform a total network access verification.

Currently, technicians use portable PC devices to complete the diagnostic portion of the installation or service call. These devices are relatively bulky and cannot be carried by a technician in a convenient location such as the technician's tool belt, toolbox, or shirt pocket. Furthermore, such devices generally require significant configuration in order to perform network diagnostic operations.

### BRIEF SUMMARY OF THE INVENTION

A device for evaluating access to a computer network from a specified location is disclosed. The device comprises an interface for connecting to the computer network at the specified location and a processor coupled to the interface, the processor capable of using the interface to access at least one network component coupled to the computer network. The result of the device attempting to access the at least one network component is used in evaluating access to the computer network from the specified location.

According to one embodiment, the device performs an IP addressing operation, such as a network ping operation, in attempting to access the at least one network component. The at least one network component may be a server located in a local network of an access provider or a server located in a local network of a consumer of an access service.

The device may further comprise at least one memory element for storing data relating to the evaluation of access to the computer network. In one embodiment, the at least one memory element stores a history of evaluation results generated over time. The device may also be capable of reporting, to a repository external to the device, data relating to the evaluation of access to the computer network. The repository may be another network component coupled to the computer network, such as a server associated with an access provider. In one embodiment, data relating to the evaluation of access to the computer network is reported to the repository using the BSD syslog protocol.

In accordance with the invention, the computer network may comprise a plurality of inter-connected networks, such as the Internet. According to one embodiment, the device is a single-purpose tool dedicated to evaluation of computer network access and is suited for extended deployment at a consumer's premises.

A further understanding of the nature and advantages of the present invention may be realized by reference to the remaining portions of the specification and the drawings.

### BRIEF DESCRIPTION OF THE DRAWINGS

FIG. 1 illustrates an environment in which an embodiment of the present invention is typically employed.

FIG. 2 provides an external view of a network access tool in accordance with one embodiment of the present invention.

FIG. 3 is a block diagram of the structure of a network access tool in accordance with one embodiment of the present invention.

### DETAILED DESCRIPTION OF THE INVENTION

In accordance with an embodiment of the invention, a tool for and method of monitoring network access and diagnosing problems therewith from remote network access points in a distributed data network is provided.

The tool diagnoses network access rather than network connectivity. That is, the tool not only verifies network physical layer link presence, but it also performs IP addressing operations to and from the various network servers to verify all network components necessary for the consumer to successfully operate on the network are accessible. These components include Dynamic Host Configuration Protocol (DHCP) servers, Domain Name System (DNS) servers, proxy servers, network time servers, e-mail servers, and web servers.

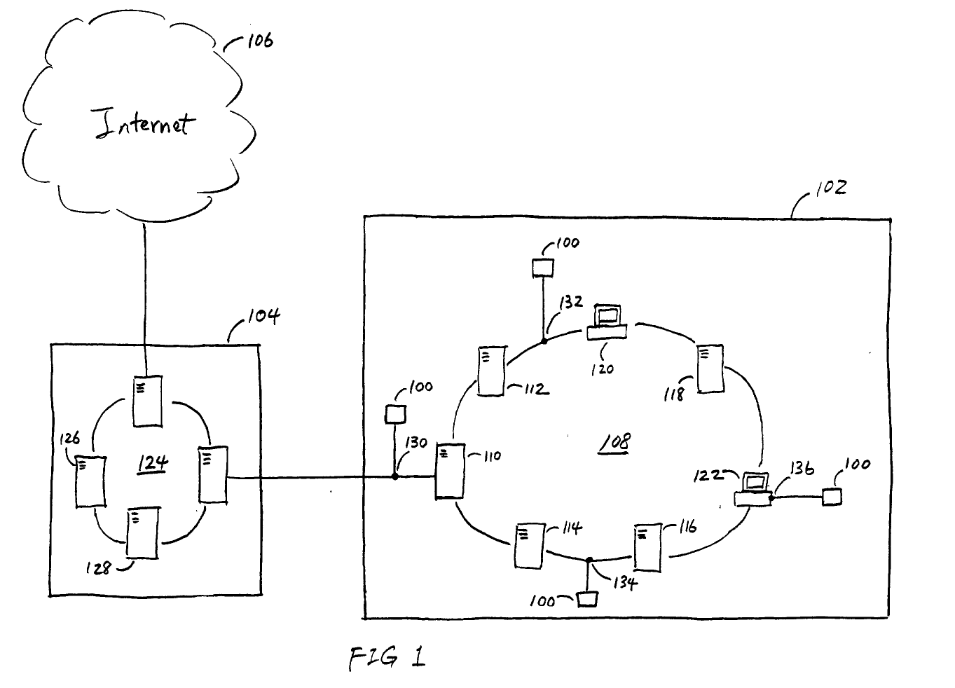

FIG. 1 illustrates an environment in which an embodiment 100 of the present invention is typically employed. Here, the environment includes access consumer's premises 102, access provider's premises 104, and the Internet 106. Access consumer's premises 102 contains an access consumer local network 108, which includes a gateway server 110, a proxy server 112, a DNS server 114, a DHCP server 116, a time server 118, and PCs 120 and 122. The access consumer local network is connected, through the gateway server 110, to an access provider local network 124 located on the access provider's premises 104. The access provider local network 124 includes an e-mail server 126 and a web server 128. The access provider local network is connected to the Internet 106. In this fashion, the access provider allows the access consumer to be connected with the Internet 106.

One or more pocket-sized units 100 is used to evaluate network access at various access points on an access consumer's premises 102. Here, a technician may use unit 100 to verify both (1) the direct network segment provided by the access provider (direct line), by connecting unit 100 to access point 130 and (2) the network segment(s) behind the gateway server 110, by connecting unit 100 at access points within the consumer's local network 108, such as access points 132 and 134. If the device works at both the direct line and the network access points within the consumer's local network 108, then the technician has a high degree of confidence that PC devices connected to the consumer's local network 108 would obtain network access. That is, any network problems encountered in setting up the consumer's PC device would likely be caused by the consumer's PC device and not by the network.

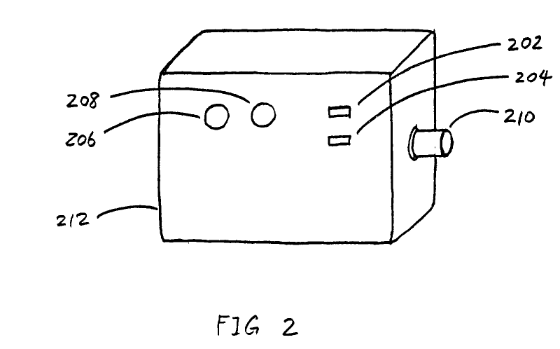

A primary motivation for a technician to use unit 100 is its small, compact size. FIG. 2 provides an external view of unit 100 in accordance with one embodiment of the present invention. Here, unit 100 is implemented as a portable device specialized for the task of evaluating network access. Unit 100 includes a red light-emitting diode (LED) 202, green LED 204, TEST switch button 206, SELECT switch button 208, and interface connector 210. The interface connector 210 may correspond to an Ethernet interface, a Universal Serial Bus (USB) interface, a Wireless Fidelity (WiFi) interface, and/or any other interface used to connect to a local network as known in the art. Here, WiFi is a term used to describe the IEEE 802.11a, b, and/or g standard. Unit 100 is contained in a pocket-sized case 212. Note that unit 100 also includes internal components not shown in FIG. 2 and may contain other external components not explicitly illustrated in this figure.

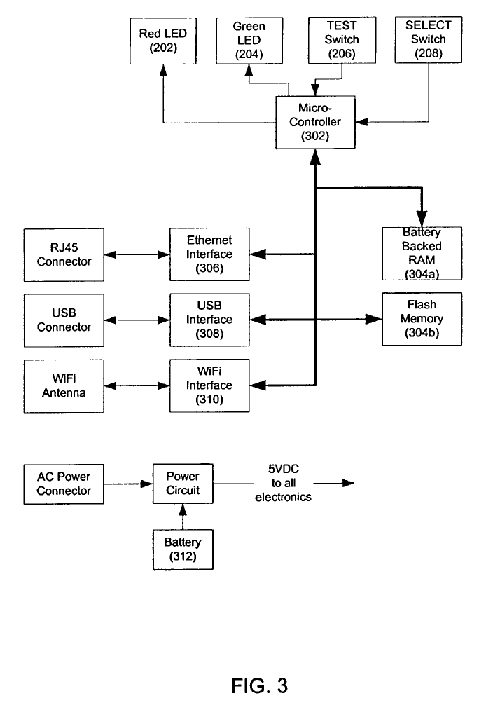

FIG. 3 is a block diagram of the structure of unit 100 in accordance with one embodiment of the present invention. As shown in FIG. 3, unit 100 includes a micro controller 302, memory 304a, 304b, Ethernet interface 306, USB interface 308, WiFi interface 310, red LED 202, green LED 204, TEST switch button 206, and SELECT switch button 208. Unit 100 can be powered from battery 312 or from an external AC to DC converter. In one embodiment, unit 100 may contain a small LCD display.

After initial installation, unit 100 operates on AC power available at the consumer's premises. It remains on the network and logs time and access diagnostics periodically. These results are accumulated and transmitted across the network to an aggregation server that provides a picture of the overall network through time. This ensures that when the technician leaves the consumer's premises, the access provider and consumer have a tool that can diagnose network access independent of the consumer's PC(s). In one embodiment, the tool may be restricted to logging of network access time/results pairs and performs no other logging. In such a manner, use of the tool would not infringe on consumer privacy.

Consumers can use the tool to self-diagnose the network within their premises before calling the CSR. Thus, the tool serves to reduce up to 30 minutes of delay per problem by first providing information in a uniform manner for the CSR and the consumer, and second by potentially eliminating the CSR call altogether.

Testing conducted with unit 100 can be initiated by pressing TEST button 216 or by activating the test using the first embedded web page. The test tracks results in the form of a failure code that identifies the nature of the failure. In the present embodiment, testing follows internet standard protocols defined by the Request for Comment (RFC) documentation published by the Internet Engineering Task Force (IETF).

In one embodiment, unit 100 operates in one of three modes: setup, direct line, and consumer's local networking. The mode can be changed using the SELECT button or by selecting the mode on the first web page embedded in unit 100. This web page can be accessed using a PC directly connect to unit 100 or a device that accesses unit 100 through the consumer's local network. The green LED 204 flashes with the mode number as follows:

1) Flashes once when entering setup mode,

2) Flashes twice when entering direct line mode,

3) Flashes three times when entering consumer's local networking mode.

In the present embodiment, each of the operating modes represents a particular selection of steps selected from the test sequence outlined below:

First, verify that a physical network link is present. If not, unit 100 flashes the red LED 202 once, logs a failure code of FF hex, and aborts the remaining tests.

2) Second, verify that an IP address can be obtained. If unit 100 is configured for DHCP, then it attempts to gain an IP address using the DHCP protocol (RFC 2131 and RFC 2132). If unit 100 is not configured for DHCP, then it uses the static address configured for the operating mode. If unit 100 cannot obtain an IP address either dynamically or statically, then it flashes the red LED 202 twice, logs a failure code of 01 hex, and aborts the remaining tests.

3) Third, if configured for the operating mode, verify that a network login is possible. This is usually configured for most cable modem access and all Point-to-Point Protocol Over Ethernet (PPPOE) (RFC 2516) access. If unit 100 does not properly login to the network, then it flashes the red LED 212 three times, logs a failure code of 02 hex, and aborts the remaining tests.

4) Fourth, if configured for the operating mode, verifies that a network ping (Internet Control Message Protocol (ICMP) method per RFC 792) can be performed to reach the network gateway. If unit 100 cannot ping the gateway, then it flashes the red LED 202 four times, logs a failure code of 03 hex, and aborts the remaining tests.

5) Fifth, if configured for the operating mode, verify that a network ping (ICMP method per RFC 792) can be performed to reach the DNS primary server. If unit 100 cannot ping the DNS primary server, then it flashes the red LED 202 five times, performs a logical AND of the previous failure code from the network gateway test with 04 hex, delays for 2 seconds, and continues with the remaining tests.

6) Sixth, if configured for the operating mode, verify that a network ping (ICMP method per RFC 792) can be performed to reach the DNS secondary server. If unit 100 cannot ping the DNS secondary server, then it flashes the red LED 202 six times, performs a logical AND of the previous failure code from the DNS primary server test above with 08 hex, delays for 2 seconds, and continues with the remaining tests.

7) Seventh, if configured for the operating mode, verify that a network ping (ICMP method per RFC 792) can be performed to reach the network proxy server. If unit 100 cannot ping the proxy server, then it flashes the red LED 202 seven times, performs a logical AND of the previous failure code from the DNS secondary server test above with 10 hex, delays for 2 seconds, and continues with the remaining tests.

8) Eighth, if configured for the operating mode, verify that network time (ICMP method per RFC 1305) can be obtained from the network time server. If unit 100 cannot access the network time server, then it flashes the red LED 202 eight times, performs a logical AND of the previous failure code from the DNS secondary server test above with 20 hex, delays for 2 seconds, and continues with the remaining tests.

9) Ninth, if configured for the operating mode, verify that a network ping (ICMP method per RFC 792) can be performed to reach the access provider's e-mail server. If unit 100 cannot ping the e-mail server, then it flashes the red LED 202 nine times, performs a logical AND of the previous failure code from the network time server test above with 40 hex, delays for 2 seconds, and continues with the remaining tests.

10) Tenth, if configured for the operating mode, verify that a network ping (ICMP method per RFC 792) can be performed to reach the access provider's web server. If unit 100 cannot ping the web server, then it flashes the red LED 202 ten times, performs a logical AND of the previous failure code from the email server test above with 80 hex, delays for 2 seconds, and continues with the remaining tests.

11) Eleventh, if all the above tests pass with no failure, unit 100 lights up the green LED 204 for 2 seconds.

12) Twelfth, unit 100 logs the failure code to its non-volatile memory 304a. The failure code will be 00 hex if there were no errors.

13) Thirteenth, the operator can cancel the tests by pressing TEST button 216 again during TEST or by selecting ABORT on the embedded web page.

14) Fourteenth, if the test is initiated through the embedded web page, then the status of all TESTs is displayed using the LAST TEST RESULTS tab on the web page.

In addition, all three operating modes allow configuration steps to be performed for configuring unit 100 using embedded web pages.

In setup mode, unit 100 attempts to obtain an IP address used to access unit 100 and its embedded web pages. In one embodiment, unit 100 attempts to obtain an IP address using test steps 1 and 2 described above. That is, unit 100 first attempts to obtain an IP address using DHCP. The same failure codes and red LED flash sequence applies. If it is successful, unit 100 flashes the green LED 204. If no address is obtained within 20 seconds, unit 100 assumes it is directly connected to a PC and responds to the fixed IP address 192.168.1.250 with a subnet mask of 255.255.255.0. The consumer then points the PC's web browser to 192.168.1.250. This activates web pages embedded within unit 100 that configures the characteristics of each operating mode. The first web page allows the user to change the mode and to navigate to the remaining web pages. Again, the web pages are accessible in each of the modes, allowing the user to configure unit 100 or otherwise input and/or retrieve data.

In another embodiment, in order to facilitate direct connection to a PC, unit 100 alters the procedure for obtaining an IP address as follows:

1) Attempts to obtain an IP address from a network DHCP server. If there is no server response, then unit 100 first pings IP addresses 192.168.1.1 and 192.168.1.254. If there is a response, unit 100 uses the IP address it was allocated from the DHCP server.

2) If there is no response to those addresses, then unit 10 assumes it is directly connected to a single PC using a crossover cable. It configures itself for operation at IP address 192.168.1.250 and serves IP address 192.168.1.251 to any computer who requests an IP address.

Once unit 100 obtains an IP address, embedded web pages of unit 100 may be accessed using the IP address obtained. For example, if unit 100 obtains a fixed IP address of 192.168.1.250, the consumer would point the PC's web browser to 192.168.1.250. This activates web pages embedded within unit 100 that configures the characteristics of each operating mode. The first web page allows the user to change the mode and to navigate to the remaining web pages.

Specifically, these embedded web pages allow configuration of the source of IP addresses for each access point verified in the test sequence. The configuration allows the IP address source to be either the DHCP response packet (per RFC 2132) or a statically configured IP address entered through the web page. Static IP addresses must be a physical IP address (such as 192.168.1.1) for the gateway and DNS servers. Either physical IP addresses or logical names may be used for the proxy, time, e-mail, and web server source identifiers.

In direct line mode, unit 100 uses the configuration setup specified in the direct line configuration web page to perform the test sequence (steps 1-14) described above. In the consumer's local networking mode, unit 100 uses the configuration setup specified in the consumer's local networking mode configuration web page to perform the test sequence (steps 1-14) described above.

When in the direct line or consumer's gateway modes of operation, unit 100 autonomously performs the network access test sequence described above and logs the results as a time/failure code data pair to the memory. The results are aggregated as a time series of time/failure code pairs and sent periodically to a server hosted within the access provider's network space. The test period and aggregation period are configured using the web pages while unit 100 is in the setup mode.

In one embodiment of the present invention, the time/failure code data is compressed as follows:

1) The first record consists of a starting time in units of seconds into the year and a test period in units of minutes.

2) The remaining records consist of only failure code results for each test period. The start of the test is implicitly defined as:

START OF TEST=START_TIME+(SAMPLE_PERIOD*FAILURE_CODE_REC_NUM)

Where START_TIME is the starting time defined in the first record,

SAMPLE_PERIOD is the test period defined in the first record, and

FAILURE_CODE_REC_NUM is the index within the transmitted message.

3) The time/failure code data is sent to the access provider's server using the Berkeley Software Distribution (BSD) syslog protocol (RFC 3164) each time the unit is powered up or when the aggregation period configured for unit 100 has expired.

4) Unit 100 tracks the time between the start of each test and the end of each test and adjusts the remaining time to begin the next test to ensure accuracy of the implicit test period.

In one embodiment, the monitoring and diagnosing tool is built from a commercial off-the-shelf (COTS) microprocessor with external 128K battery-backed RAM and external 128K flash memory chips. It also contains an external Ethernet controller and RJ-45 Ethernet connector, an external USB controller and USB connector, and an external WiFi controller and WiFi antenna. This tool contains one green LED and one red LED for displaying the status of the tool when used autonomously. It contains one TEST switch push button and one SELECT switch push button that are pushed by the operator to control the tool manually rather than from the embedded web pages.

In another embodiment, the tool contains commercial off-the-shelf software that implements the Hypertext Transfer Protocol (HTTP) (RFC 1945), DHCP (RFC 2131), ICMP (RFC 792), FTP (RFC 414) and network driver functions. Further, the tool may contain specialized embedded software written both in the C programming language and the assembly programming language to initialize and manage the LEDs, switches, and network operations of the tool as described above.

In another embodiment, the tool contains specialized web pages that implement the web functions described above.

In yet another embodiment, the tool supports complete erasure of its configuration information using the following sequence of events:

1) Depressing and holding the SELECT button for 2 seconds while in the setup mode,

2) Depressing and releasing the TEST button once at which point the tool flashes the green LED once,

3) Depressing and holding the TEST button at which point the tool flashes the red LED once.

4) Releasing the SELECT button for 2 seconds while holding the TEST button at which point the tool flashes the green LED once,

5) Depressing and releasing the SELECT button while holding the TEST button at which point the tool flashes the red LED once,

6) Releasing the TEST button at which point the tool flashes the green and red LEDs concurrently and erases all configuration information from its memory.

Thus, in accordance with an embodiment of the invention, a network tool is provided that monitors, logs, and reports the success or failure of a consumer's local network to gain access to general internet network capabilities through a contracted service. This tool incorporates salient elements of network instrumentation into a small unit suitable for widespread deployment into consumer's premises. It can be used by the consumer and the internet access provider such that the consumer can diagnose the network and verify the quality of service (QoS) he or she receives. It incorporates support for the access provider independent of the consumer's equipment in a package suitable for deployment at consumer's premises. In another embodiment the tool is embedded in the hardware (e.g., bridges and gateway devices) at the consumer site.

In accordance with one aspect of the invention, a single red LED and single green LED are used to convey consumer network access information.

In accordance with another aspect of the invention, a SELECT switch is used to change device mode, and a single green LED is used to convey the mode back to the user.

In accordance with another aspect of the invention, an algorithm is provided for determining whether the tool is directly connected to a consumer PC as described above, and allowing the consumer PC to connect directly to the tool without performing a manual consumer PC device configuration change.

In accordance with another aspect of the invention, one eight bit byte is used to describe consumer network access status.

In accordance with another aspect of the invention, time is encoded into a single 32 bit word that represents seconds into the year.

In accordance with another aspect of the invention, a single-purpose tool for verifying consumer network access includes a micro-controller, RAM, FLASH memory, Ethernet interface, USB interface, and WiFi interface.

In accordance with another aspect of the invention, two buttons and two LEDs are used to erase device configuration information and reset the tool to factory settings while maintaining sufficient safety measures that the device configuration is not inadvertently erased. That is, performing a non-trivial sequence using the two buttons and two LEDs that is difficult to learn and retain without either a manual or everyday use and knowledge of the tool to provide a high degree of operator assurance and confidence. In another embodiment, this algorithm is not available through the network interface for security purposes.

In accordance with another aspect of the invention, the tool autonomously isolates consumer premises network access problems at separate access points using a mode as described in paragraph 72 above without the concurrent coordination of another machine.

In accordance with another aspect of the invention, the tool autonomously verifies consumer premises access points in the order of the installing technician as described in paragraph 72 above without concurrent coordination of another machine.

In accordance with another aspect of the invention, the tool autonomously provides results to an access provider agent and a network service consumer in a form that both parties can understand and easily synchronize using standard voice across telephone verbal communications.

In accordance with another aspect of the invention, the tool autonomously logs network access results from the perspective of the network service consumer and provides those results to the access provider for the purposes of analyzing network performance, diagnoses network faults, proactively diagnoses faults for preventative maintenance, and correlates with other access provider data to determine network reliability issues.

In accordance with another aspect of the invention, the tool autonomously logs network access results from the perspective of the network service consumer and provides those results to the access provider for the purposes of correlating with other access provider bandwidth data for establishing network performance degradation vulnerabilities as a function of time so that network equipment can be added at the optimal time as the network grows.

In accordance with another aspect of the invention, an algorithm is used to compress failure code time sequence data using implicit time.

In accordance with another aspect of the invention, an algorithm is used to periodically test network access, aggregate results into a single byte, and log the results to an external server using the BSD syslog protocol.

Thus, among other features and advantages of the different embodiments of the invention, a baseline of network access can be established sufficient to determine the reliability aspect of a contracted internet service using a access provider configured tool within a consumer network. Such tool allows the network service consumer to self-diagnose network access with a minimum of training. Also, the tool helps reduce the number of calls to access provider agents and representatives. Further, the tool helps reduce the number of on-site visits by access provider agents and representatives. Moreover, the tool helps restore consumer confidence in the contracted network service by identifying consumer network and equipment problems without human interaction with the access provider agents and representatives.

Although the present invention has been described in terms of specific embodiments, it should be apparent to those skilled in the art that the scope of the present invention is not limited to the described specific embodiments. The specification and drawings are, accordingly, to be regarded in an illustrative rather than a restrictive sense. It will, however, be evident that additions, subtractions, substitutions, and other modifications may be made without departing from the broader spirit and scope of the invention as set forth in the claims.

What is claimed is:

1 A portable evaluation device comprising:
an interface configured to connect to a computer network at a specified location;
a processor coupled to said interface, said processor capable of using said interface to access at least one network component coupled to said computer network; and
wherein result of said device attempting to access said at least one network component is used in evaluating access to said computer network from said specified location.

2. The device of claim 1, wherein said attempt to access said at least one network component comprises an IP addressing operation.

3. The device of claim 2, wherein said IP addressing operation comprises a network ping operation.

4. The device of claim 1, wherein said at least one network component is a server.

5. The device of claim 4, wherein said at least one network component is selected from the group consisting of a DNS server, a DHCP server, a proxy server, an e-mail server, and a web server.

6. The device of claim 4, wherein said server is located in a local network of an access provider.

7. The device of claim 4, wherein said server is located in a local network of a consumer of an access service.

8. The device of claim 1, further comprising at least one indicator for providing information relating to operation of said device.

9. The device of claim 8, wherein said at least one indicator is a visual indicator.

10. The device of claim 9, wherein said visual indicator is a light emitting diode (LED).

11. The device of claim 10, wherein said LED illuminates in a plurality of flash sequences to indicate different results relating to operation of said device.

12. The device of claim 11, wherein said LED is the only indicator providing immediate information to a user relating to operation of said device.

13. The device of claim 9, wherein said visual indicator is a liquid crystal display (LCD).

14. The device of claim 1, wherein said device generates at least one failure code describing access to said computer network as evaluated by said device.

15. The device of claim 14, wherein said at least one failure code consists of one byte of data.

16. The device of claim 14, wherein at least one bit in said failure code represents result of said device verifying existence of a physical network link.

17. The device of claim 14, wherein at least one bit in said failure code represents result of said device attempting to obtain an IP address.

18. The device of claim 14, wherein at least one bit in said failure code represents result of said device attempting to perform a network login.

19. The device of claim 14, wherein at least bit in said failure code represents result of said device attempting to perform an IP addressing operation corresponding to said at least one network component.

20. The device of claim 19, wherein said IP addressing operation comprises a network ping operation.

21. The device of claim 1, wherein said device attempts to access a plurality of network components coupled to said computer network.

22. The device of claim 21, wherein result of said device attempting to access each of said plurality of network components is represented by a bit in a failure code.

23. The device of claim 1, further comprising at least one memory element for storing data relating to said evaluation of access to said computer network.

24. The device of claim 23 wherein said at least one memory element stores a history of evaluation results generated over time.

25. The device of claim 24, wherein said history of evaluation results comprises a plurality of time/failure code pairs, each time/failure code pair containing a time portion relating to time at which a particular test took place and a failure code portion relating to data collected during said test.

26. The device of claim 1, wherein said device is capable of reporting, to a repository external to said device, data relating to said evaluation of access to said computer network.

27. The device of claim 26, wherein said repository is another network component coupled to said computer network.

28. The device of claim 27, wherein said other network component is a server associated with an access provider.

29. The device of claim 26, wherein said repository is said network component coupled to said computer network.

30. The device of claim 26, wherein said data relating to said evaluation of access to said computer network is compressed before being reported to said repository.

31. The device of claim 30, wherein said compressed data comprises a starting time, a test interval, and a plurality of failure code results.

32. The device of claim 26, wherein said data relating to said evaluation of access to said computer network is reported to said repository using the BSD syslog protocol.

33. The device of claim 1, wherein said device is capable of being configured by accessing at least one web page embedded within said device.

34. The device of claim 33, wherein said at least one web page is accessed using a network component coupled to said computer network.

35. The device of claim 33, wherein said at least one web page is accessed using a PC directly connected to said device.

36. The device of claim 33, wherein said at least one web page enables a user to input at least one IP address corresponding to said at least one network component.

37. The device of claim 33, wherein said at least one web page enables a user to input at least one IP address corresponding to said device.

38. The device of claim 1, wherein said device is directly connected to a computer at a consumer's premises using at least one crossover cable.

39. The device of claim 1, wherein said device performs an algorithm for determining whether it is directly connected to a computer at a consumer's premises.

40. The device of claim 1, wherein configuration information for said device may be erased.

41. The device of claim 40, wherein said configuration information is erased by performing a non-trivial sequence of user input operations.

42. The device of claim 1, further comprising at least one user input element allowing a user to provide input into said device.

43. The device of claim 42, wherein said at least one user input element is a push button.

44. The device of claim 43, wherein no other input element besides said push button allows said user to provide immediate input into said device.

45. The device of claim 1, wherein said computer network comprises a plurality of inter-connected networks.

46. The device of claim 45, wherein said plurality of inter-connected networks is the Internet.

47. The device of claim 45, wherein said plurality of inter-connected networks includes at least one network associated with an access provider.

48. The device of claim 45, wherein said plurality of inter-connected networks includes at least one local network on a consumer's premises.

49. The device of claim 1, wherein said specified location is a direct line location on a consumer's premises.

50. The device of claim 1, wherein said specified location is a location within a local network on a consumer's premises.

51. The device of claim 1, wherein said device can function in a plurality of operation modes.

52. The device of claim 1, wherein said device operates independently of any consumer premises equipment.

53. The device of claim 1, wherein said device is embedded in at least one consumer premises equipment.

54. The device of claim 53, wherein said at least one consumer premises equipment is a bridge device.

55. The device of claim 53, wherein said at least one consumer premises equipment is a gateway device.

56. The device of claim 1, wherein said device is capable of operating from battery power.

57. The device of claim 1, wherein said device is capable of operating from alternating current (AC) power.

58. The device of claim 1, wherein said device is suited for extended deployment at a consumer's premises.

59. The device of claim 1, wherein said device is a single-purpose tool dedicated to evaluation of computer network access.

60. An apparatus for evaluating network operability comprising:
an interface configured to connect to said computer network at a particular location; and
a processor coupled to said interface, said processor capable of establishing communication using said interface with at least one server coupled to said computer network,
wherein said communication with said at least one server verifies network operability of said location.

61. An evaluation device comprising:
a repository for receiving data relating to evaluation of access to said computer network from a specified location,
wherein said repository is a network component coupled to said computer network.

62. A computer network evaluation method comprising:
connecting an interface to a specified location;
using said interface, attempting to access at least one network component coupled to said computer network; and
using result of attempting to access said at least one network component for evaluating access to said computer network from said specified location.

63. The method of claim 62, further comprising the step of storing data relating to said evaluation of access to said computer network.

64. The method of claim 63, wherein said data relating to said evaluation of access to said computer network comprises a history of evaluation results generated over time.

65. The method of claim 62, further comprising the step of reporting, to a repository, data relating to said evaluation of access to said computer network.

66. A system for computer network evaluation comprising:
means for connecting to said specified location;
means for using said connecting means to attempt to access at least one network component coupled to said computer network; and
means for evaluating access to said computer network from said specified location, using result of attempting to access said at least one network component.
